(19) United States
(12) Patent Application Publication
(10) Pub. No.: US 2007/0195469 A1
(43) Pub. Date: Aug. 23, 2007

(54) Magnetoresistive effect element, magnetic head, magnetic reproducing apparatus, and manufacturing method of magnetoresistive effect element

(75) Inventors: Masahiro Takashita, Yokohama-shi (JP); Masayuki Takagishi, Tokyo (JP); Hitoshi Iwasaki, Yokosuka-shi (JP); Shiho Nakamura, Fujisawa-shi (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/595,996

(22) Filed: Nov. 13, 2006

(30) Foreign Application Priority Data
Feb. 17, 2006 (JP) P2006-040643

(51) Int. Cl. G11B 5/33; G11B 5/127

(52) U.S. Cl. 360/324.12; 360/322

(57) ABSTRACT

A magnetoresistive effect element includes: a magnetoresistive effect film including a magnetization free layer, a magnetization fixed layer, and an intermediate layer placed between them; a magnetic coupling layer; a ferromagnetic layer; an antiferromagnetic layer; a bias mechanism portion applying a bias magnetic field to the magnetization free layer in a direction nearly parallel to a film surface of the magentoresistive effect film and nearly perpendicular to a magnetization direction of the magnetization fixed layer; and a pair of electrodes to pass a current in a direction going from the magnetization fixed layer to the magnetization free layer, and its bias point is more than 50%.

### CROSS-REFERENCE TO THE INVENTION

This application is based upon and claims the benefit of priority from the prior Japanese Patent Application No. 2006-040643, filed on Feb. 17, 2006; the entire contents of which are incorporated herein by reference.

### BACKGROUND OF THE INVENTION

1. Field of the Invention

The present invention relates to a magnetoresistive effect element in which a current is applied perpendicular to a film surface of the magnetoresistive effect element, a magnetic head, a magnetic reproducing apparatus, and a manufacturing method of a magnetoresistive effect element.

2. Description of the Related Art

A GMR head using a GMR element showing a GMR effect (Giant Magneto Resistive effect) is widely used when in a magnetic recording/reproducing apparatus such as a hard disk, information on a magnetic recording medium storing information is reproduced.

A spin-valve type GMR element is constituted by a stacked film including a magnetization fixed layer, a magnetization free layer, and an intermediate layer placed between them. The magnetization fixed layer has a magnetic material film whose magnetization direction is substantially fixed to one direction by an antiferromagnetic film or the like. The magnetization direction of the magnetic material film changes according to an external magnetic field (for example, a signal magnetic field of a magnetic recording medium, usually parallel or antiparallel to the magnetization of the magnetization fixed layer).

Using a longitudinal bias mechanism (for example, a magnetic domain control film for which a cobalt-platinum alloy or a cobalt-chrome-platinum alloy is preferably used), a longitudinal bias magnetic field is applied to the magnetization free layer nearly parallel to a film surface of a magnetoresistive effect film and nearly perpendicular to the magnetization of the magnetization fixed layer. Consequently, if there is no signal magnetic field, the magnetization direction of the magnetization fixed layer and the magnetization direction of the magnetization free layer become nearly perpendicular, which makes it possible to avoid Barkhausen noise. The GMR effect is produced by the relative angle change between the magnetization of the magnetization fixed layer and the magnetization of the magnetization free layer.

Here, a CIP (Current In Plane)-GMR element and a CPP (Current Perpendicular to Plane)-GMR element are included in the GMR element. In the former, the magnetoresistive effect is detected by passing a sense current nearly in the plane of the stacked film. In the latter, the magnetoresistive effect is detected by passing the sense current in a direction nearly perpendicular to the staked film.

Compared to the CIP-GMR element, the CPP-GMR element can obtain a higher output even in the case of a very small track width, and thereby easily respond to a higher recording density. In the CIP-GMR element, the sense current is passed in the plane of the stacked film, so that a region where the GMR effect is produced becomes smaller as the recording track width becomes narrower, which causes a reduction in resistance change amount ΔR. On the other hand, in the CPP-GMR element, the sense current is passed in a stack direction so that the amount of a reduction in resistance change amount ΔR caused by narrowing of the recording track width is small.

Incidentally, a technique for adjusting a bias point regarding the CIP-GMR element is published (see JP-A 2000-137906 (reference 1)).

### BRIEF SUMMARY OF THE INVENTION

As the recording density is becoming higher, the size of a magnetic head is becoming increasingly smaller both in a track width direction and in a height direction. For example, in a magnetic recording apparatus/magnetic reproducing apparatus such as a hard disk, the track width/height become approximately 100 nm or less.

In this case, if the CPP-GMR element is used for the magnetic head, there is a possibility that current induced magnetization switching (spin-transfer) occurs. In the current induced magnetization switching, the magnetization direction of a magnetization free layer substantially changes due to current induced magnetization switching and the magnetization response of the magnetization free layer to an external magnetic field becomes smaller. This current induced magnetization switching is markedly exhibited in an element whose track width and height is 100 nm or less (it becomes easy to form a single magnetic domain, so that the influence of an edge domain or the like becomes smaller).

In view of the above, an object of the present invention is to provide a magnetoresistive effect element which realizes the reduction of the current induced magnetization switching, a magnetic head, a magnetic reproducing apparatus, and a manufacturing method of a magnetoresistive effect element.

A magnetoresistive effect element according to one aspect of the present invention comprises: a magnetoresistive effect film including a magnetization free layer whose magnetization direction changes according to an external magnetic field, a magnetization fixed layer whose magnetization direction is substantially fixed to one direction, and an intermediate layer placed between the magnetization free layer and the magnetization fixed layer; a magnetic coupling layer placed on the magnetization fixed layer of the magnetoresistive effect film; a ferromagnetic layer placed on the magnetic coupling layer; an antiferromagnetic layer placed on the ferromagnetic layer; a bias mechanism portion applying a bias magnetic field to the magnetization free layer in a direction nearly parallel to a film surface of the magentoresistive effect film and nearly perpendicular to the magnetization direction of the magnetization fixed layer; and a pair of electrodes to pass a current in a direction going from the magnetization fixed layer to the magnetization free layer, wherein a bias point is more than 50%.

A manufacturing method of a magnetoresistive effect element according to one aspect of the present invention comprises: forming a structure comprising: a magnetoresistive effect film including a magnetization free layer whose magnetization direction changes according to an external magnetic field, a magnetization fixed layer whose magnetization direction is substantially fixed to one direction, and an intermediate layer placed between the magnetization free layer and the magnetization fixed layer; a magnetic coupling layer placed on the magnetization fixed layer of the magnetoresistive effect film; a ferromagnetic layer placed on the magnetic coupling layer; an antiferromagnetic layer placed on the ferromagnetic layer; a bias mechanism portion applying to the magnetization free layer a bias magnetic field in a direction nearly parallel to a film surface of the magentoresistive effect film and nearly perpendicular to the magnetization direction of the magnetization fixed layer; and a pair of electrodes to pass a current in a direction going from the magnetization fixed layer to the magnetization free layer; and giving an initial magnetization direction whose angle with respect to the magnetization direction of the magnetization fixed layer is 100° or larger and smaller than 160° to the magnetization free layer.

### BRIEF DESCRIPTION OF THE DRAWINGS

FIG. 1A is a sectional view showing a section of a current-perpendicular-to-plane type magnetoresistive effect element according to a first embodiment of the present invention.

FIG. 1B is a schematic diagram showing magnetization directions of the current-perpendicular-to-plane type magnetoresistive effect element according to the first embodiment of the present invention viewed from the upper surface thereof.

FIG. 2 is a schematic diagram to describe a bias point.

FIG. 3A is a schematic diagram showing a current-passing direction and a magnetic field generated by a current in CIP-GMR.

FIG. 3B is a schematic diagram showing a current-passing direction and a magnetic field generated by a current in CPP-GMR.

FIG. 4 is a flowchart showing an example of a procedure for fabricating the current-perpendicular-to-plane type magnetoresistive effect element according to the first embodiment.

FIG. 5 is a sectional view showing the current-perpendicular-to-plane type magnetoresistive effect element fabricated by the procedure in FIG. 4.

FIG. 6 is a sectional view showing the current-perpendicular-to-plane type magnetoresistive effect element fabricated by the procedure in FIG. 4.

FIG. 7 is a sectional view-showing a section of a current-perpendicular-to-plane type magnetoresistive effect element according to a second embodiment of the present invention.

FIG. 8 is a flowchart showing an example of a procedure for fabricating the current-perpendicular-to-plane type magnetoresistive effect element according to the second embodiment.

FIG. 9 is a sectional view showing a section of a current-perpendicular-to-plane type magnetoresistive effect element according to a third embodiment of the present invention.

FIG. 10 is a flowchart showing an example of a procedure for fabricating the current-perpendicular-to-plane type magnetoresistive effect element according to the third embodiment.

FIG. 11 is a perspective view of a major portion exemplifying a schematic structure of a magnetic recording/reproducing apparatus according to one embodiment of the present invention.

FIG. 12 is an enlarged perspective view showing a magnetic head assembly according to the one embodiment of the present invention.

FIG. 13 is a graph showing an example of a magnetic field-resistance characteristic of the current-perpendicular-to-plane type magnetoresistive effect element.

FIG. 14 is a graph showing an example of the magnetic field-resistance characteristic of the current-perpendicular-to-plane type magnetoresistive effect element.

FIG. 15 is a graph showing an example of the magnetic field-resistance characteristic of the current-perpendicular-to-plane type magnetoresistive effect element

FIG. 16 is a graph showing an example of the magnetic field-resistance characteristic of the current-perpendicular-to-plane type magnetoresistive effect element

FIG. 17 is a graph showing an example of the magnetic field-resistance characteristic of the current-perpendicular-to-plane type magnetoresistive effect element.

FIG. 18 is a graph showing an example of the magnetic field-resistance characteristic of the current-perpendicular-to-plane type magnetoresistive effect element.

FIG. 19 is a graph showing an example of the magnetic field-resistance characteristic of the current-perpendicular-to-plane type magnetoresistive effect element

FIG. 20 is a graph showing an example of the magnetic field-resistance characteristic of the current-perpendicular-to-plane type magnetoresistive effect element.

FIG. 21 is a graph showing an example of the magnetic field-resistance characteristic of the current-perpendicular-to-plane type magnetoresistive effect element.

### DETAILED DESCRIPTION OF THE INVENTION

Embodiments of the present invention will be described in detail below with reference to the drawings.

### First Embodiment

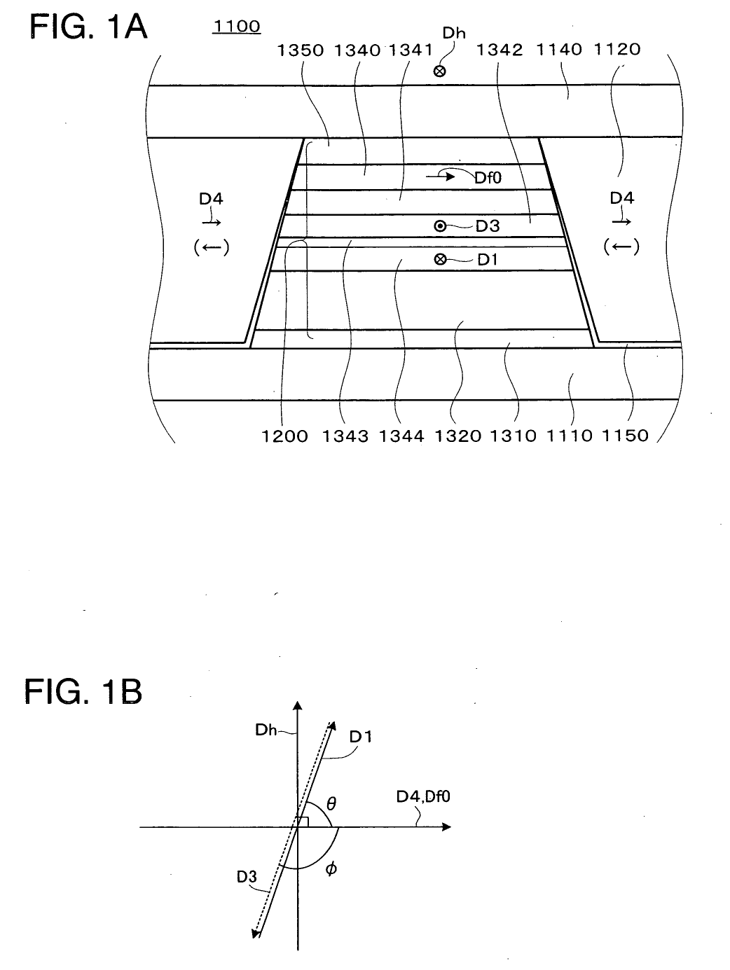

FIG. 1A is a sectional view showing a section of a current-perpendicular-to-plane type magnetoresistive effect element according to a first embodiment. This figure shows a section viewed from a recording medium facing surface facing a magnetic recording medium from which information is to be read. A current-perpendicular-to-plane type magnetoresistive effect element 1100 detects a signal magnetic field H with a direction Dh going from the front side to the back side of the paper surface as a positive direction.

The current-perpendicular-to-plane type magnetoresistive effect element 1100 includes a spin-valve film 1200, a pair of magnetic domain control films 1120, a lower shield layer 1110, and an upper shield layer 1140.

The lower shield layer 1110 and the upper shield layer 1140 are placed so as to sandwich the magnetic domain control films 1120 and the spin-valve film 1200 therebetween along a stack direction. The lower shield layer 1110 and the upper shield layer 1140 are made of a NiFe alloy or the like and serve as a lower electrode and an upper electrode, respectively.

The spin-valve film 1200 is constituted of a multilayer film. Namely, the spin-valve film 1200 includes a foundation layer 1310, an antiferromagnetic layer 1320, a ferromagnetic layer 1344, a magnetic coupling layer 1343, a magnetization fixed layer 1342, an intermediate layer 1341, a magnetization free layer 1340, and a protective layer 1350 in order from the side of the lower shield layer 1110.

The foundation layer 1310 is made of, for example, Ta, and improves an exchange coupling between the antiferromagnetic layer 1320 and the ferromagnetic layer 1344 or improves the degree of crystallization of the whole spin-valve film.

The antiferromagnetic layer 1320 is formed of, for example, a PtMn alloy or an X—Mn (Note that X is any one kind or two or more kinds of elements out of Pd, Ir, Rh, Ru, Os, Ni, and Fe) alloy or a Pt—Mn—X1 (Note that X1 is any one kind or two or more kinds of elements out of Pd, Ir, Rh, Ru, Au, Ag, Os, Cr, and Ni) alloy. By heat-treating these alloys, the antiferromagnetic layer 1320 which generates a large exchange coupling magnetic field can be obtained. Incidentally, there is a possibility that the antiferromagnetic layer 1320 contains any of Ar, Ne, Xe, and Kr as an impurity (used in a manufacturing process such as sputtering).

The antiferromagnetic layer 1320 has a function of fixing (pinning) a magnetization direction D1 of the ferromagnetic layer 1344. As will be described later, the magnetization direction D1 of the ferromagnetic layer 1344 is determined by performing heat treatment while applying a magnetic field in a state where the antiferromagnetic layer 1320 and the ferromagnetic layer 1344 overlap each other.

As described above, the magnetization direction D1 of the ferromagnetic layer 1344 is fixed by the antiferromagnetic layer 1320. In FIG. 1A, the magnetization direction D1 being the direction going from the front side to the back side of the paper surface (direction perpendicular to the paper surface) is shown. Note, however, that the magnetization direction D1 is slightly displaced from the direction perpendicular to the paper surface.

The ferromagnetic layer 1344, the magnetic coupling layer 1343, and the magnetization fixed layer 1342 form a so-called synthetic antiferromagnet (SyAF). Namely, the ferromagnetic layer 1344 and the magnetization fixed layer 1342 are antiferromagnetically coupled to each other via the magnetic coupling layer 1343. As a result, a magnetization direction D3 of the magnetization fixed layer 1342 becomes opposite (antiparallel) to the magnetization direction D1 of the ferroelectric layer 1344.

The ferromagnetic layer 1344 and the magnetization fixed layer 1342 are usually constituted of a material containing at least one of Fe, Co, Ni, and Mn, and may have either a single-layer structure or a multilayer structure. The ferromagnetic layer 1344 and the magnetization fixed layer 1342 can have, for example, a stacked structure of a CoFe alloy and Cu.

The magnetic coupling layer 1343 can be constituted of a nonmagnetic metal material such as copper, gold, Ru, Rh, or Ir.

The intermediate layer 1341 mainly functions so as to separate a magnetic coupling between the magnetization free layer 1340 and the magnetization fixed layer 1342. The intermediate layer 1341 can be constituted of, for example, a nonmagnetic metal material such as copper or gold having a high electric conductivity. As the intermediate layer 1341, an insulator (Al₂O₃) in which an electric conductor (such as Cu) is placed may be used.

The magnetization free layer 1340 is a layer whose magnetization direction changes according to the direction of an external magnetic field, and constituted of, for example, an NiFe alloy or a multilayer film of an NiFe alloy and a CoFe alloy. The protective layer 1350 is a layer which protects the spin-valve film 1200 after deposition in the manufacturing process and constituted of, for example, Cu, Ta, or Ru.

The pair of magnetic domain control films 1120 are placed facing each other so as to correspond to a width direction of a recording track of the magnetic recording medium. A pair of insulating layers 1150 are placed between the spin-valve film 1200 and the pair of magnetic domain control films 1120.

The magnetic domain control film 1120 (for which a CoPt alloy, a CoCrPt alloy, or the like is preferably used) is formed on the insulating layer 1150 (for which Al₂O₃, AlN, or the like is preferably used).

The magnetic domain control film 1120 acts as a longitudinal bias mechanism portion and applies a longitudinal bias magnetic field to the magnetization free layer 1340. Namely, the magnetic domain control film 1120 has a magnetization direction D4, and the direction of the longitudinal bias magnetic field is determined by this magnetization direction D4. The direction of the longitudinal bias magnetic field is usually nearly parallel to a film surface of a magnetoresistive effect film and nearly perpendicular to the magnetization direction D3 of the magnetization fixed layer 1342.

A magnetization direction Df0 (initial magnetization direction Df0) of the magnetization free layer 1340 when the external magnetic field H is not applied is defined by the longitudinal bias magnetic field. In FIG. 1A, since the magnetization direction D4 is directed to the right of the paper surface, the initial magnetization direction Df0 is also directed to the right. Incidentally, the magnetization direction D4 may be directed to the left of the paper surface.

Here, it is possible to adjust a bias point by inclining the magnetization direction D3 of the magnetization fixed layer 1342 (in other words, the magnetization direction D1 of the ferromagnetic layer 1344) from a direction perpendicular to the magnetization direction D4 of the magnetic domain control film 1120.

FIG. 1B is a schematic diagram showing magnetization directions of the current-perpendicular-to-plane type magnetoresistive effect element viewed from the upper surface thereof. An angle θ formed by the magnetization direction D4 of the magnetic domain control film 1120 and the magnetization direction D1 of the ferromagnetic layer 1344 is shown. If the magnetization directions D4 and D1 are parallel, the angle θ=0° holds (θ=180° if they are antiparallel). By making the absolute value of the angle θ smaller than 90° (preferably, 80° or smaller), the bias point can be adjusted (|θ|<90°).

At this time, the absolute value of an angle φ formed by the initial magnetization direction Df0 of the magnetization free layer 1340 with respect to the magnetization direction D3 of the magnetization fixed layer 1342 is larger than 90° (|φ|>90°, φ=180°−θ). Namely, the magnetization directions D3 and Df0 are on antiparallel sides. An antiparallel relationship between the magnetization directions D3 and Df0 causes a reduction in current induced magnetization switching. The details thereof will be described later.

Even if the magnetization direction D1 of the ferromagnetic layer 1344 is displaced here, the angle formed by the magnetization direction D4 of the magnetic domain control film 1120 and the direction Dh of the signal magnetic field H is maintained at about 90°.

### (Details of Adjustment of Bias Point)

The inventor et al. have advanced research and development, paying attention to current induced magnetization switching when the longitudinal bias magnetic field is applied to a stacked film. As a result, they have found a method for suppressing noise caused by the current induced magnetization switching.

Incidentally, the GMR element is different from devices such as an MRAM (Magnetic Random Access Memory) to which the current induced magnetization switching is applied in that both the signal magnetic field from the magnetic recording medium and the longitudinal bias magnetic field by the magnetic domain control film 1120 are applied to the stacked film.

### A. Bias Point

Before a description of the adjustment of the bias point, the meaning of the bias point will be described.

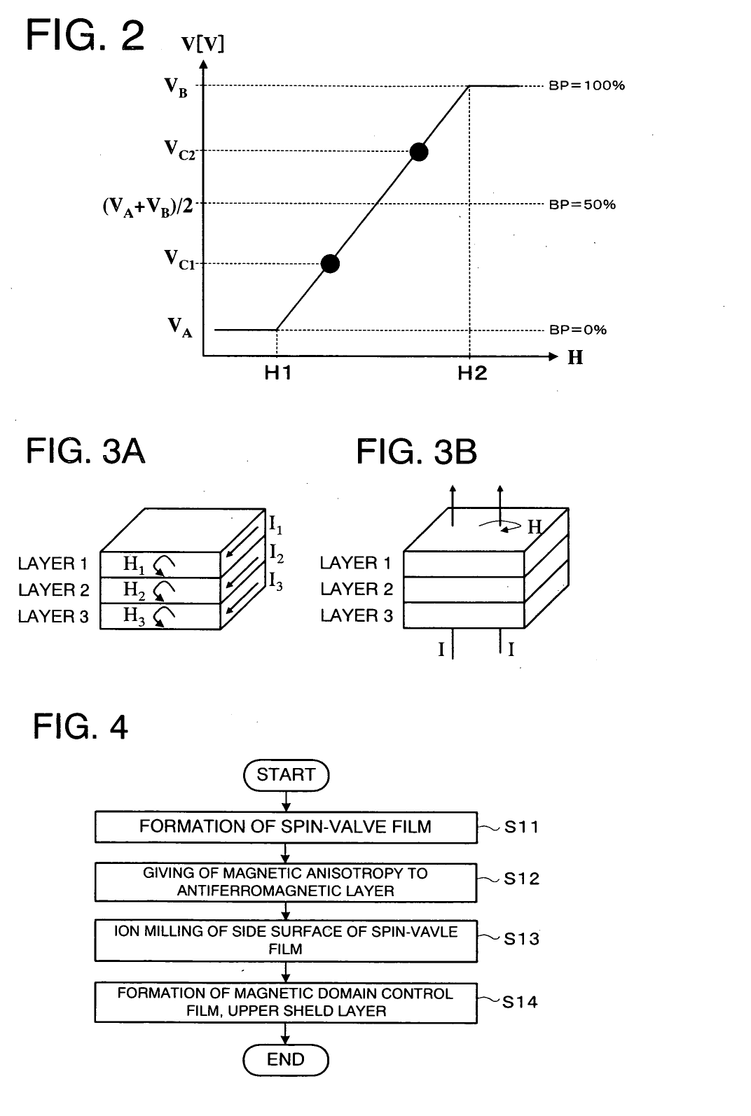

FIG. 2 is a schematic diagram to describe the bias point, and the horizontal axis shows the signal magnetic field H and the vertical axis shows an output V of the current-perpendicular-to-plane type magnetoresistive effect element 1100.

Here, a constant sense current I is passed through the current-perpendicular-to-plane type magnetoresistive effect element 1100 to change the signal magnetic field H, and the output (voltage) V of the current-perpendicular-to-plane type magnetoresistive effect element is measured. As a result, a graph (generally called a transfer curve) showing the relation between the signal magnetic field H and the output (voltage) V is obtained.

If the signal magnetic field H is changed to positive or negative, the output V changes in a certain range (the signal magnetic field from H1 to H2 in FIG. 2). If the signal magnetic field H exceeds this range of change, the output V becomes a roughly constant value V_{A} or V_{B}. The output when the signal magnetic field H is zero is taken as V_{C} (shown as V_{C1} and V_{C2} as examples in FIG. 2).

A bias point BP is a factor showing where the output V_{C} when the signal magnetic field H is zero is located in the region of change (V_{B}−V_{A}) and can be defined by the following equation (1).

BP=(V_{C}−V_{A})/(V_{B}−V_{A})×100[%] Equation (1)

Incidentally, the positive and negative of the signal magnetic field H are defined as follows. Namely, a magnetic field nearly antiparallel to the magnetization direction D3 of the magnetization fixed layer 1342 (magnetic field parallel to the magnetization direction D1 of the ferromagnetic layer 1344) is the magnetic field in a positive direction (Dh in FIG. 1A). On the other hand, a magnetic field nearly parallel to the magnetization direction D3 of the magnetization fixed layer 1342 is the magnetic field in a negative direction.

If the output V when the signal magnetic field H is zero is V_{A}, V_{B}, and ((V_{A}+V_{B})/2) in FIG. 2, the bias point BP becomes 0%, 100%, and 50%, respectively. If the output V when the signal magnetic field H is zero is V_{C1} and V_{C2}, the bias point BP becomes smaller than 50% in the former, and the bias point BP becomes larger than 50% in the latter.

A method for calculating the bias point BP will be specifically described below. Here, an applied voltage to the current-perpendicular-to-plane type magnetoresistive effect element 1100 (voltage applied between the lower shield layer 1110 and the upper shield layer 1140) is set sufficiently low (desirably between several mV and approximately 30 mV at the highest). By setting the applied voltage to a low voltage, the output with little noise caused by the current induced magnetization switching can be obtained, which makes it possible to calculate the bias point more accurately.

Incidentally, to pass the current through the lower shield layer 1100 and the upper shield layer 1140, usually wiring is connected to these layers. Therefore, there is a possibility that voltage drop due to the wiring occurs and thereby a slight difference arises between the voltage applied to the wiring and the original applied voltage. However, in many cases, the wiring resistance is 1/10 or less of the resistance of the spin-valve film, so that the voltage drop due to the wiring is negligible. In such a case, there is no problem even if the voltage applied to the wiring is used instead of the original applied voltage.

When the signal magnetic field H is sufficiently low (the value of which is negative), the magnetization direction of the magnetization fixed layer 1342 and the magnetization direction of the magnetization free layer 1340 are close to parallel, so that the output V is as low as V_{A}. On the other hand, when the signal magnetic field H is sufficiently high (the value of which is positive), the magnetization direction of the magnetization fixed layer 1342 and the magnetization direction of the magnetization free layer 1340 are close to antiparallel, so that the output V becomes as high as V_{B}. The output V_{C} when the signal magnetic field H is zero becomes between V_{A} and V_{B}. At this time, the bias point BP is calculated from the above-described equation (1).

A resistance value R when the signal magnetic field H is sufficiently low (the value of which is negative) is taken as R_{A}, the resistance value R when the signal magnetic field H is sufficiently high (the value of which is positive) is takes an R_{B}, and the resistance value R when the signal magnetic field H is zero is taken as R_{C}. At this time, the bias point BP is calculated from the following equation (2).

BP=(R_{C}−R_{A})/(R_{B}−R_{A})×100[%] Equation (2)

Another method for calculating the bias point BP is a method of measuring the output voltage V (or the resistance R) at the time of the predetermined positive or negative signal magnetic field H. The output V_{C} (or R_{C}) when the signal magnetic field H is zero and the outputs V_{A} and V_{B} (or R_{A} and R_{B}) when the signal magnetic field is predetermined positive and negative magnetic fields are measured. Then, using the equation (1) or the equation (2), the bias point BP is calculated.

Here, usually the absolute values of the positive and negative signal magnetic fields H are made equal. For example, if the predetermined positive signal magnetic field H is +400 [Oe], the predetermined negative signal magnetic field H is set to −400 [Oe] whose absolute value is the same but direction is opposite.

At this time, it is desirable that the absolute value of the signal magnetic field H be set so as to exceed the range (from H1 to H2 in FIG. 2) corresponding to the range of change of the output. Such a method is not different from the method for calculating the bias point BP based on the transfer curve in its result.

As described above, two ways to decide the bias point BP, that is, the equations (1) and (2), are conceivable, but they are substantially the same and a difference in the bias point BP between the equations (1) and (2) is virtually negligible. Note, however, that in this specification, the bias point BP is basically defined based on the change of the resistance value R due to the signal magnetic field H (equation (2)).

### B. Difference in Meaning of Bias Point between CIP-GMR and CPP-GMR

FIG. 3A and FIG. 3B are schematic views showing current-passing directions and magnetic fields generated by currents in CIP-GMR and CPP-GMR, respectively. Here, to facilitate understanding, it is assumed that CIP-GMR and CPP-GMR each have a magnetic resistance film constituted of three layers of layer 1 to layer 3.

In CIP-GMR, a current flows parallel to the layer 1 to the layer 3, so that the magnitudes of currents I1 to I3 flowing through the layer 1 to the layer 3, respectively, are different because of differences in resistivity and so on among the layer 1 to the layer 3. Accordingly, by the corkscrew rule, magnetic fields H1 (layer 1), H2 (layer 2), and H3 (layer 3) generated from the-currents I1, I2, and I3 are different from one another.

Consequently, in CIP-GMR, the bias point BP changes according to the balance among the magnetic fields H1, H2, and H3, and it becomes important to balance these magnetic fields H1, H2, and H3. Incidentally, the above-described reference 1 discloses a technique therefor.

On the other hand, in CPP-GMR, a current flows perpendicular to the layer 1 to the layer 3 (across the layer 1 to layer 3), so that currents flowing through the layer 1 to layer 3 become substantially equal. Hence, magnetic fields generated from the currents flowing through the layer 1 to the layer 3 become substantially equal. Therefore, in CPP-GMR, unlike in the case of CIP-GMR, the change in the bias point due to the difference among the magnetic fields generated in the respective layers does not occur.

Current induced magnetization switching is a phenomenon in which the magnetization transfers between the magnetization fixed layer 1342 and the magnetization free layer 1340 through the spin angular momentum of conduction electrons taking charge of the current and thereby the magnetization direction of the magnetization free layer 1340 is reversed.

### Case of CPP-GMR

The current induced magnetization switching in CPP-GMR will be described.

Let's assume a case where the magnetization direction of the magnetization fixed layer 1342 and the magnetization direction of the magnetization free layer 1340 are antiparallel. In this case, by passing the current from the magnetization free layer 1340 to the magnetization fixed layer 1342, the magnetization of the magnetization free layer 1340 is reversed, and the magnetic resistance reduces. The reason for this will be described below.

In this case, the direction in which electrons flow is a direction opposite to the current and going from the magnetization fixed layer 1342 to the magnetization free layer 1340. When passing through the magnetization fixed layer 1342, the electrons are polarized in the same direction as the magnetization of the magnetization fixed layer 1342 (spin angular momentum polarization). The polarized electrons pass through the intermediate layer 1341 and enter the magnetization free layer 1340. At this time, spin angular momentum transfers between the conduction electrons and the magnetization free layer 1340. As a result, the magnetization direction of the magnetization free layer 1340 is reversed to become identical to the magnetization direction of the magnetization fixed layer 1342.

As described above, due to the electrons flowing from the magnetization fixed layer 1342 to the magnetization free layer 1340, the magnetization direction of the magnetization free layer 1340 becomes parallel to the magnetization direction of the magnetization fixed layer 1342.

On the other hand, let's assume a case where the magnetization direction of the magnetization fixed layer 1342 and the magnetization direction of the magnetization free layer 1340 are parallel. In this case, by passing the current from the magnetization fixed layer 1342 to the magnetization free layer 1340, the magnetization of the magnetization free layer 1340 is reversed, and the magnetic resistance increases. The reason for this will be described below.

In this case, the direction in which electrons flow is a direction going from the magnetization free layer 1340 to the magnetization fixed layer 1342. The conduction electrons in the magnetization free layer 1340 are polarized in the same direction as the magnetization of the magnetization free layer 1340. At this time, not all the conduction electrons are polarized, and conduction electrons not polarized also exist. The electrons not polarized are reflected by an interface between the magnetization fixed layer 1342 and the intermediate layer 1341 and return to the magnetization free layer 1340. Spin angular momentum transfers between the conduction electrons which have returned to the magnetization free layer 1340 and the magnetization of the magnetization free layer 1340. As a result, the magnetization direction of the magnetization free layer 1340 is reversed to become opposite to the magnetization direction of the magnetization fixed layer 1342.

As described above, due to the electrons flowing from the magnetization free layer 1340 to the magnetization fixed layer 1342 and reflected by a boundary therebetween, the magnetization direction of the magnetization free layer 1340 becomes antiparallel to the magnetization direction of the magnetization fixed layer 1342. Note, however, that the reversal of the magnetization direction caused by the reflected electrons has a smaller influence than the reversal of the magnetization direction caused by the electrons flowing from the magnetization fixed layer 1342 into the magnetization free layer 1340. This is because compared to the electrons passing through the boundary, the ratio of electrons reflected by the boundary is not always larger.

As described above, if the flow of electrons is set (a) in the direction from the magnetization fixed layer 1342 to the magnetization free layer 1340, the current induced magnetization switching tends to occur. In contrast, if the flow of electrons is set (b) in the direction from the magnetization free layer 1340 to the magnetization fixed layer 1342, the current induced magnetization switching does not relatively tend to occur.

Namely, by setting the flow of electrons (b) in the direction from the magnetization free layer 1340 to the magnetization fixed layer 1342 (the flow of the current is set in the direction from the magnetization fixed layer 1342 to the magnetization free layer 1340), noise due to the current induced magnetization switching can be reduced. As will be described later, in this embodiment, by adjusting the bias point in addition to the above, a further reduction in noise due to the current induced magnetization switching is realized.

### Case of CIP-GMR

In CIP-GMR, the current induced magnetization switching does not need to be considered. Namely, in CIP-GMR, the current is concentrated in any layer with a high electric conductivity (generally, the intermediate layer formed of Cu). Therefore, the transfer of spin angular momentum between layers does not occur.

As described above, the current induced magnetization switching can be said to be a phenomenon peculiar to CPP-GMR.

### C. Adjustment of Bias Point

As described above, by setting the current direction to the direction from the magnetization fixed layer 1342 to the magnetization free layer 1340, the noise due to the current induced magnetization switching can be reduced. It turns out that in addition to this, the adjustment of the bias points BP is important in order to avoid the current induced magnetization switching. Namely, by adjusting the bias point BP, the noise due to the current induced magnetization switching can be further reduced.

To measure both the positive and negative magnetic fields with a high degree of sensitivity, the bias point BP is usually set to 50%. By contrast, by making the bias point BP more than 50% (more preferably, making the bias point BP 55% or more and 80% or less), the current induced magnetization switching can be reduced.

### Relation between Bias Point and Magnetization Direction

The bias point less than 50% means that the change of the magnetic resistance in the external magnetic field H in the positive direction is large. The bias point more than 50% means that the change of the magnetic resistance in the external magnetic field H in the negative direction is large. As just described, whether or not the bias point is more than 50% corresponds to the negative direction or the positive direction of the external magnetic field H in which the magnetic resistance greatly changes.

The magnitude of the bias point BP depends on the angular relationship between the magnetization direction D3 of the magnetization fixed layer 1342 and the initial magnetization direction Df0 of the magnetization free layer 1340. If the angle φ formed by the magnetization directions D3 and Df0 (see FIG. 1B) is 90°, the bias point BP becomes 50%. If the angle φ is smaller than 90°, the bias point BP becomes less than 50%. If the angle φ is larger than 90°, the bias point BP becomes more than 50%.

The reason why the bias point BP changes according to the angle φ formed by the magnetization directions D3 and Df0 as described above will be described below. Before the description, the relation between the external magnetic field H and the magnetization direction Df of the magnetization free layer 1340 will be described.

The magnetization direction Df of the magnetization free layer 1340 changes from the initial magnetization direction Df0 by the external magnetic field H, and consequently the magnetic resistance changes. At this time, the magnetization direction Df of the magnetization free layer 1340 rotates to the left or right according to the positive or negative of the external magnetic field H. When the magnetization direction Df rotates to the left or right and approaches a state parallel or antiparallel to the magnetization direction D3 of the magnetization fixed layer 1342, further rotation is restricted. As just described, the magnetization direction Df of the magnetization free layer 1340 moves in a range smaller than ±90° relative to the initial magnetization direction Df0, so that the magnetic resistance changes.

When the angle φ formed by the magnetization directions D3 and Df0 is 90°, the range of change of the magnetization direction Df becomes nearly symmetric between positive and negative ranges (left rotation and right rotation) with respect to the initial magnetization direction Df0. Namely, if the absolute values of the external magnetic field are equal, the amounts of change of magnetic resistance become about equal even if their signs are different (one positive and one negative). This means that the bias point is 50%. More specifically, when the angle φ formed by the magnetization directions D3 and Df0 is 90°, the range of change of the magnetization direction Df becomes symmetric between positive and negative angles, and the bias point becomes 50%.

If the angle φ formed by the magnetization directions D3 and Df0 is displaced from 90°, the positive and negative symmetry of the range of change of the magnetization direction Df is lowered, and the bias point is displaced from 50%. If the angle φ formed by the magnetization directions D3 and Df0 is larger than 90°, the bias point BP becomes more than 50%. The relation between the angle φ formed by the magnetization directions D3 and Df0 and the bias point BP can be described as above.

### Relation between Magnetization Direction and Current Induced Magnetization Switching

As described above, in this embodiment, the sense current is passed from the magnetization fixed layer 1342 to the magnetization free layer 1340. Therefore, the current induced magnetization switching acts so that the magnetization direction D3 of the magnetization fixed layer 1342 and the magnetization direction Df of the magnetization free layer 1340 are antiparallel. Namely, if the magnetization direction Df of the magnetization free layer 1340 is parallel to the magnetization direction D3 of the magnetization fixed layer 1342, the current induced magnetization switching tends to occur. On the other hand, if the magnetization direction Df of the magnetization free layer 1340 is antiparallel to the magnetization direction D3 of the magnetization fixed layer 1342, the current induced magnetization switching does not occur.

As describe above, the probability of occurrence of the current induced magnetization switching depends on whether the magnetization direction Df of the magnetization free layer 1340 and the magnetization direction D3 of the magnetization fixed layer 1342 are close to parallel or antiparallel (in other words, whether the angle φ formed thereby is larger or smaller than 90°). If the absolute value of the angle φ formed by the magnetization directions Df and D3 is larger than 90°, the probability of occurrence of the current induced magnetization switching is reduced.

### Relation between Bias Point and Current Induced Magnetization Switching

As described above, the bias point more than 50% means that the angle φ formed by the magnetization direction D3 of the magnetization fixed layer 1342 and the initial magnetization direction Df0 of the magnetization free layer 1340 is larger than 90°. This case means that the magnetization direction Df of the magnetization free layer 1340 is displaced to the side antiparallel to the magnetization direction D3 of the magnetization fixed layer 1342, thereby enabling a reduction in current induced magnetization switching.

As described above, the magnetization direction Df of the magnetization free layer 1340 changes from the initial magnetization direction Df0 if the external magnetic field H is changed. Therefore, there is a possibility that the antiparallel relationship between the magnetization direction Df of the magnetization free layer 1340 and the magnetization direction D3 of the magnetization fixed layer 1342 is collapsed by the application of the external magnetic field H. However, the magnetization direction Df of the magnetization free layer 1340 before the application of the external magnetic field H, that is, the initial magnetization direction Df0 is a dominant factor for the reduction in current induced magnetization switching.

A method for adjusting the bias point BP will be described below. The bias point BP can be adjusted by the initial magnetization direction Df0 of the magnetization free layer 1340. More specifically, the absolute value of the angle φ formed by the magnetization direction D3 of the magnetization fixed layer 1342 and the initial magnetization direction Df0 of the magnetization free layer 1340 is made larger than 90° (preferably, 100° or larger) and smaller than 160° (90°<|φ|<160°). As a result, the bias point becomes larger than 50%. Plural methods can be used for this adjustment.

### (1) Adjustment by Magnetic Thicknesses of Magnetization Fixed Layer 1342 and Ferromagnetic Layer 1344

The bias point BP can be adjusted by controlling magnetic thicknesses of the magnetization fixed layer 1342 and the ferromagnetic layer 1344.

Namely, the control is performed such that a saturation magnetization Ms1 and a thickness t1 of the magnetization fixed layer 1342 and a saturation magnetization Ms2 and a thickness t2 of the ferromagnetic layer 1344 satisfy the following equation (3).

1.2≦(Ms1×t1)/(Ms2×t2)<5 Equation (3)

Here, in magnetic layers such as the ferromagnetic layer 1344, the magnetic coupling layer 1343, and the magnetization fixed layer 1342, the product of saturation magnetization and thickness is magnetic thickness.

As described above, the ferromagnetic layer 1344 and the magnetization fixed layer 1342 are antiferromagnetically coupled to each other via the magnetic coupling layer 1343 and form the so-called synthetic antiferromagnet (SyAF). In this case, it is thought to be desirable that by “Ms1×t1=Ms2×t2”, a magnetic field leaking from the ferromagnetic layer 1344 and a magnetic field leaking from the magnetization fixed layer 1342 be substantially cancelled, thereby obtaining a bias point of 50%.

However, it is known that “1.2≦(Ms1×t1)/(Ms2×t2)” can suppress the noise due to the current induced magnetization switching. In this case, the leakage magnetic field from the ferromagnetic layer 1344 becomes relatively larger, and the angle φ formed by the magnetization direction D3 of the magnetization fixed layer 1342 and the initial magnetization direction Df0 of the magnetization free layer 1340 becomes larger than 90° (more preferably, φ is 100° or larger). As a result, the bias point becomes more than 50%.

When the magnetic thickness Ms1×t1 of the magnetization fixed layer 1342 is larger than the magnetic thickness Ms2×t2 of the ferromagnetic layer 1344, the leakage magnetic field from the magnetization fixed layer 1342 becomes relatively larger. The direction of the leakage magnetic field in this case becomes opposite to the magnetization direction D3 of the magnetization fixed layer 1342 in the magnetization free layer 1340. Hence, if the magnetic thickness Ms1×t1 is made larger than the magnetic thickness Ms2×t2, the bias point becomes more than 50%. In order to make the bias point substantially more than 50%, “1.2≦(Ms1×t1)/(Ms2×t2)” is given.

On the other hand, when the magnetic field leaking from the ferromagnetic layer 1344 is too large compared to the external magnetic field or a magnetic field from the medium, the sensitivity (change in output) to the external magnetic field (magnetic field from the medium) lowers. In this case, the bias point is too large (for example, 100% or very close thereto). To avoid this, “(Ms1×t1)/(Ms2×t2)<5” is desirable.

To make the magnetic thicknesses of the magnetic fixed layer 1342 and the ferromagnetic layer 1344 different from each other, at least either the thickness or composition of each of them needs to be controlled. For example, different materials are used for the magnetization fixed layer 1342 and the ferromagnetic layer 1344. As an example, instead of Co₉₀Fe₁₀, Co₈₀FE₂₀ or Co is used for one of the magnetization fixed layer 1342 and the ferromagnetic layer 1344.

### (2) Adjustment by Coupling Magnetic Field between Magnetization Free Layer 1340 and Magnetization Fixed Layer 1342

The bias point can be controlled by strengthening an interlayer coupling magnetic field between the magnetization free layer 1340 and the magnetization fixed layer 1342 and weakening the longitudinal bias magnetic field. For example, the bias point BP can be made more than 50% by making the interlayer coupling magnetic field more than 150 [Oe] and reducing the magnetic thickness of the magnetic domain control film 1120, which is usually 3.0 [memu/cm²], to about 1.5 [memu/cm²].

By strengthening the interlayer coupling magnetic field, the magnetization of the magnetization free layer 1340 and the magnetization of the magnetization fixed layer 1342 easily become antiparallel, and consequently the bias point BP becomes more than 50%. Further, bymaking the magnetic thickness of the magnetic domain control film 1120 smaller compared to the interlayer coupling magnetic field, the bias point can be made more than 50% (if the magnetic thickness of the magnetic domain control film 1120 is made much larger compared to the interlayer coupling magnetic field, the bias point BP gets closer to 50%).

### (3) Adjustment by Magnetization Direction of Ferromagnetic Layer 1344

As described above, the bias point can be made more than 50% by making the absolute value of the magnetization direction D1 of the ferromagnetic layer 1344 smaller than 90° (preferably, 80° or smaller) with respect to the magnetization direction D4 of the magnetic domain control film 1120.

### (4) Combination of Above Methods of (1) to (3)

The above methods of (1) to (3) can be used in combination with one another. For example, the bias point BP can be adjusted by controlling both (1) the magnetic thicknesses of the magnetization fixed layer 1342 and the ferromagnetic layer 1344 and (3) the magnetization direction of the ferromagnetic layer 1344.

Even if the methods of (1) to (3) are combined, the absolute value of the angle φ of the initial magnetization direction Df0 of the magnetization free layer 1340 with respect to the magnetization direction D3 of the magnetization fixed layer 1342 can be made larger than 90°. Moreover, combination of plural methods makes it possible to reduce variations between elements and improve yields compared to when any one of methods is used.

### (Fabrication of Magnetoresistive Effect Element 1100)

Next, a method for fabricating the current-perpendicular-to-plane type magnetoresistive effect element 1100 will be described.

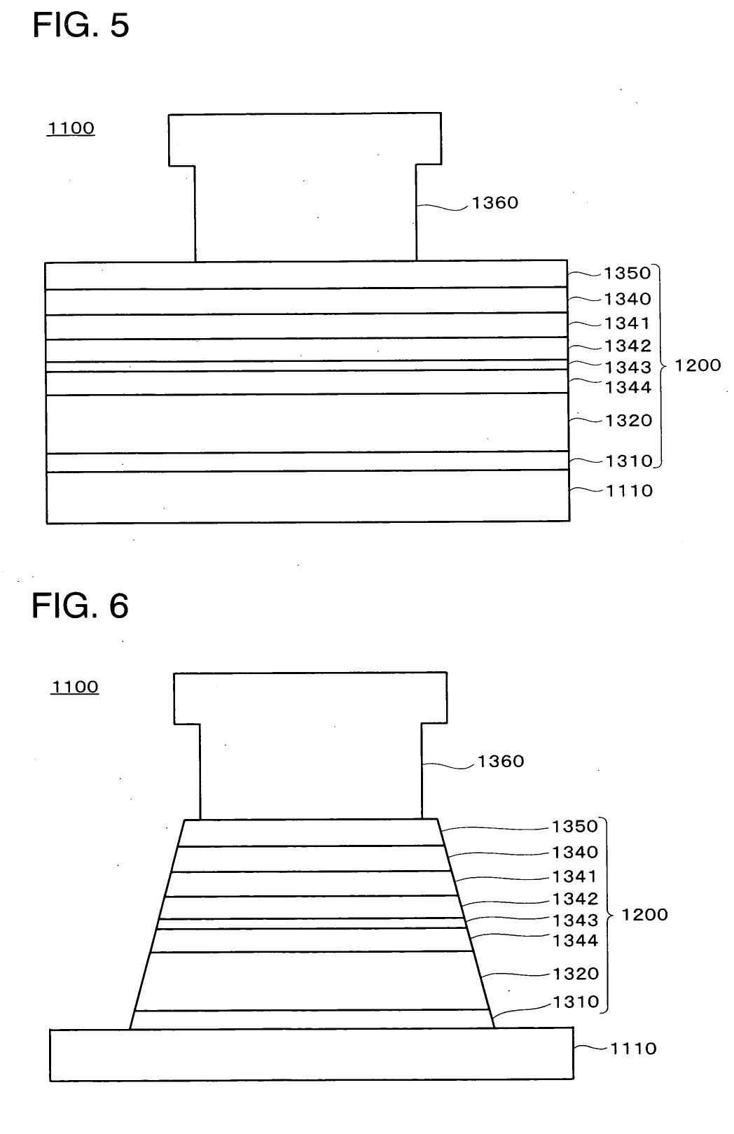

FIG. 4 is a flowchart showing an example of a procedure for fabricating the current-perpendicular-to-plane type magnetoresistive effect element 1100. FIG. 5 and FIG. 6 are sectional views showing the current-perpendicular-to-plane type magnetoresistive effect element 1100 fabricated by the procedure in FIG. 4.

### (1) Formation of Spin-Valve Film 1200 (step S11)

The spin-valve film 1200 is formed on a substrate not shown. Namely, the lower shield layer 1110, the foundation layer 1310, the antiferromagnetic layer 1320, the ferromagnetic layer 1344, the magnetic coupling layer 1343, the magnetization fixed layer 1342, the intermediate layer 1341, and the magnetization free layer 1340 are deposited (see FIG. 5). Incidentally, FIG. 5 shows a state a later-described resist layer 1360 is added.

Here, by properly adjusting the materials and thicknesses of the magnetization fixed layer 1342 and the ferromagnetic layer 1344 when the spin-valve film 1200 is formed, the above equation (3) can be satisfied and thereby the bias point BP can be adjusted.

Deposition by a sputtering apparatus, for example, is used for formation of the respective layers. In sputter deposition, any of a DC magnetron sputtering method, an RF magnetron sputtering method, an ion beam sputtering method, a long throw sputtering method, and a collimation sputtering method, or a sputtering method of a combination thereof can be used.

### (2) Giving of Exchange Coupling Magnetic Field to Antiferromagnetic Layer 1320 (step S12)

An exchange coupling magnetic field (magnetic anisotropy) is given to the antiferromagnetic layer 1320. More specifically, the exchange coupling magnetic field can be given by combining the application of a magnetic field and heat treatment. Namely, the magnetic field H is applied in a state where the antiferromagnetic layer 1320 is heat-treated to a temperature T higher than a blocking temperature, and then the antiferromagnetic layer 1320 is cooled.

The blocking temperature means a temperature at which the magnetic anisotropy of the antiferromagnetic layer 1320 disappears (in other words, a temperature at which the exchange coupling between the antiferromagnetic layer 1320 and the ferromagnetic layer 1344 is cutoff). Therefore, by setting the temperature T to a temperature higher than the blocking temperature, the magnetic anisotropy of the antiferromagnetic layer 1320 temporarily disappears. Thereafter, when the antiferromagnetic layer 1320 is cooled to a temperature lower than the blocking temperature, the exchange coupling magnetic field (magnetic anisotropy) is given to the antiferromagnetic layer 1320 according to the applied magnetic field.

Incidentally, the magnitude of the exchange coupling magnetic field differs according to crystal grain size distribution in the film and the degree of vacuum at the time of deposition. In PtMs, the exchange coupling magnetic field increases with an increase in thickness, whereas in IrMn, the exchange coupling magnetic field decreases with an increase in thickness.

At this time, it is usually the case that the direction of the magnetic field H when the antiferromagnetic layer 1320 is heat-treated is made perpendicular to the magnetization direction of the magnetic domain control film 1120. In this case, the angle θ of the magnetization direction D1 of the ferromagnetic layer 1344 with respect to the magnetization direction D4 of the magnetic domain control film 1120 becomes 90°. As a result, the bias point becomes 50%, and the sensitivity of the element rises.

In contrast, it is assumed that the direction of the magnetic field H when the antiferromagnetic layer 1320 is heat-treated is larger than 10° and 80° or smaller with respect to the magnetization direction D4 of the magnetic domain control film 1120. As a result, the angle θ of the magnetization direction D1 of the ferromagnetic layer 1344 with respect to the magnetization direction D4 of the magnetic domain control film 1120 becomes larger than 10° and 80° or smaller. In this case, the bias point becomes more than 50%.

### (3) Ion Milling of Side Surface of Spin-Valve Film 1200 (Step S13)

After the resist layer 1360 is formed on the formed spin-valve film 1200 (see FIG. 5), a side surface thereof is removed to part of the foundation layer 1310 by ion milling (see FIG. 6).

### (4) Formation of Magnetic Domain Control Film 1120 and Upper Shield Layer 1140 (step S14)

The insulating layer 1150 and the magnetic domain control film 1120 are deposited on the side surface of the spin-valve film 1200 after removal. Then, after the resist layer 1360 is removed, the upper shield layer 1140 is deposited (see FIG. 1).

### Second Embodiment

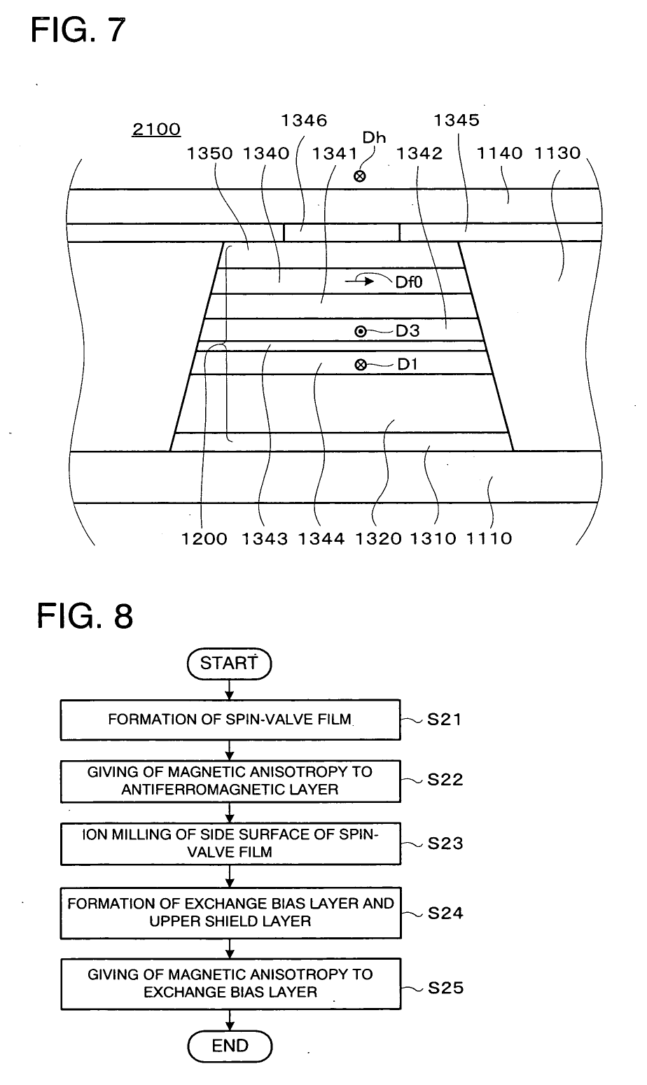

FIG. 7 is a sectional view showing a section of a current-perpendicular-to-plane type magnetoresistive effect element 2100 according to a second embodiment of the present invention.

The current-perpendicular-to-plane type magnetoresistive effect element 2100 of this embodiment is different from the current-perpendicular-to-plane type magnetoresistive effect element 1100 of the first embodiment in the following points (1) and (2). Namely, (1) instead of the magnetic domain control film 1120 and the insulating layer 1150, an insulator 1130 is placed. Further, (2) an exchange bias layer 1345 and an upper electrode layer 1346 are placed between the protective layer 1350 and the upper shield layer 1140.

Incidentally, between the exchange bias layer 1345 and the protective layer 1350, a ferromagnetic layer made of a ferromagnetic material or a layer made of a soft magnetic material or a nonmagnetic material may be placed.

In this embodiment, the longitudinal bias magnetic field is generated by the exchange bias layer 1345 in place of the magnetic domain control film 1120 of the first embodiment. More specifically, the exchange bias layer 1345 applies the longitudinal bias magnetic field to the magnetization free layer 1340 by the exchange coupling magnetic field (it functions as the longitudinal bias mechanism portion).

The direction of the longitudinal bias magnetic field at this time is nearly parallel to the film surface of the magnetoresistive effect film (spin-valve film 1200) and nearly perpendicular to the magnetization direction of the magnetization fixed layer 1342. By displacing this angle from a perpendicular angle, the bias point BP can be adjusted. Incidentally, the details thereof will be described later.

With the placement of the exchange bias layer 1345 on the spin-valve film 1200, the upper electrode layer 1346 is placed, and thereby a voltage is applied to the spin-valve film 1200. Namely, in this embodiment, the voltage is applied between the upper electrode layer 1346 and the lower shield layer 1110, whereby the sense current flows through the spin-valve film 1200 (the upper shield layer 1140 does not also serve as the upper electrode).

Similarly to the antiferromagnetic layer 1320, the exchange bias layer 1345 can be formed of a PtMn alloy or an X—Mn (Note that X is any one kind or two or more kinds of elements out of Pd, Ir, Rh, Ru, Os, Ni, and Fe) alloy or a Pt—Mn—X1 (Note that X1 is any one kind or two or more kinds of elements out of Pd, Ir, Rh, Ru, Au, Ag, Os, Cr, and Ni) alloy. Incidentally, there is a possibility that the exchange bias layer 1345 contains any of Ar, Ne, Xe, and Kr as an impurity (used in a manufacturing process such as sputtering).

### (Adjustment of Bias Point)

A method for adjusting the bias point in the second embodiment will be described below.

As described above, the angle of the magnetic moment which antiferromagnetically produces magnetic order in the exchange bias layer 1345 is basically nearly perpendicular to the magnetization direction D3 of the magnetization fixed layer 1342. By displacing this angle from the perpendicular angle, the bias point BP can be adjusted.

The magnetization direction of the magnetization free layer 1340 changes in accordance with the exchange coupling magnetic field of the exchange bias layer 1345. The direction of the exchange coupling magnetic field from the exchange bias layer 1345 becomes parallel to the direction of a magnetic field applied to the exchange bias layer 1345 during heat treatment. Therefore, if the magnetic field applied to the exchange bias layer 1345 during heat treatment is displaced from the direction nearly perpendicular to the magnetization direction of the magnetization fixed layer 1342, the initial magnetization direction Df0 of the magnetization free layer 1340 is also displaced from the direction nearly perpendicular thereto. As a result, the bias point BP is adjusted.

This method (the method for adjusting the bias point by the magnetization directions of the exchange bias layer 1345 and the magnetization fixed layer 1342) corresponds to the method (3) out of the methods (1) to (4) described in the first embodiment. In this embodiment, instead of this method, it is also possible to adopt the methods (1), (2), or (4) described in the first embodiment.

### (Fabrication of Magnetoresistive Effect Element 2100)

A method for fabricating the current-perpendicular-to-plane type magnetoresistive effect element 2100 will be described.

FIG. 8 is a flowchart showing an example of a procedure for fabricating the current-perpendicular-to-plane type magnetoresistive effect element 2100.

### (1) Formation of Spin-Valve Film 1200 (step S21)

Step S21 is not essentially different from step S11 in the first embodiment, so that a detailed description is omitted.

### (2) Giving of Exchange Coupling Magnetic Field to Antiferromagnetic Layer 1320 (step S22)

An exchange coupling magnetic field (magnetic anisotropy) is given to the antiferromagnetic layer 1320. More specifically, the exchange coupling magnetic field can be given by combining the application of a magnetic field and heat treatment. Namely, a first magnetic field H1 is applied in a state where the antiferromagnetic layer 1320 is heat-treated to a first temperature T1 higher than a first blocking temperature, and then the antiferromagnetic layer 1320 is cooled.

Incidentally, step S22 is performed before the formation of the exchange bias layer 1345 (step S24). It is performed to prevent element diffusion due to heating in the exchange bias layer 1345 from occurring and the exchange coupling magnetic field from lowering.

The first blocking temperature means a temperature at which the magnetic anisotropy of the antiferromagnetic layer 1320 disappears (in other words, a temperature at which the exchange coupling between the antiferromagnetic layer 1320 and the ferromagnetic layer 1344 is cut off). Therefore, by setting the first temperature T to a temperature higher than the first blocking temperature, the magnetic anisotropy of the antiferromagnetic layer 1320 temporarily disappears. Thereafter, when the antiferromagnetic layer 1320 is cooled to a temperature lower than the first blocking temperature, the magnetic-anisotropy is given to the antiferromagnetic layer 1320 according to the applied magnetic field.

### (3) Ion Milling of Side Surface of Spin-Valve Film 1200 (Step S23)

After a resist layer is formed on the formed spin-valve film 1200, a side surface thereof is removed to part of the foundation layer 1310 by ion milling.

### (4) Formation of Exchange Bias Layer 1345 and Upper Shield Layer 1140 (Step S24)

The insulator 1130 is formed on the side surface of the spin-valve film 1200 after removal. Then, after the resist layer is removed, the exchange bias layer 1345, the upper electrode layer 1346, and the upper shield layer 1140 are deposited (see FIG. 7).

### (5) Giving of Exchange Coupling Magnetic Field to Exchange Bias Layer 1345 (Step S25)

A magnetic anisotropy is given to the exchange bias layer 1345. Namely, a second magnetic field H2 is applied in a state where the exchange bias layer 1345 is heat-treated to a second temperature T2 (lower than the first temperature) higher than a second blocking temperature, and then the exchange bias layer 1345 is cooled.

To give different magnetic anisotropies to the antiferromagnetic layer 1320 and the exchange bias layer 1345, materials with different blocking temperatures are used for the antiferromagnetic layer 1320 and the exchange bias layer 1345. Heat treatment while a magnetic field is applied is performed in order, starting from the material with a higher blocking temperature. For example, PtMn is selected as a constituent material of the antiferromagnetic layer 1320, and IrMn is selected as a constituent material of the exchange bias layer 1345. In this case, the second blocking temperature of the exchange bias layer 1345 becomes lower than the first blocking temperature of the antiferromagnetic layer 1320.

Incidentally, the magnitude of the exchange coupling magnetic field differs according to crystal grain size distribution in the film and the degree of vacuum at the time of deposition. In PtMs, the exchange coupling magnetic field increases with an increase in thickness, whereas in IrMn, the exchange coupling magnetic field decreases with an increase in thickness.

Here, it is usually the case that the direction of the magnetic field H2 when the exchange bias layer 1345 is heat-treated is made perpendicular to the magnetization direction H1 when the antiferromagnetic layer 1320 is heat-treated. As a result, the bias point becomes 50%, and the sensitivity of magnetoresistive effect element with respect to both positive and negative magnetic fields can be ensured.

By contrast, by displacing the direction of the magnetic field H2 to the exchange bias layer 1345 from the direction perpendicular to the direction of the magnetic field H1 to the antiferromagnetic layer 1320, the bias point can be adjusted. More specifically, the direction of the magnetic field H1 when the antiferromagnetic layer 1320 is heat-treated is made 100° or larger and smaller than 160° with respect to the direction of the magnetic field H2 when the exchange bias layer 1345 is heat-treated. As a result, the bias point BP can be made more than 50%.

### Modified Example of Second Embodiment

The current-perpendicular-to-plane type magnetoresistive effect element, as a longitudinal bias mechanism, may include both the exchange bias layer 1345 and the magnetic domain control film 1120.

Also in this case, the bias point BP can be adjusted by displacing the angle of the magnetic moment of the exchange bias-layer 1345.

### Third Embodiment

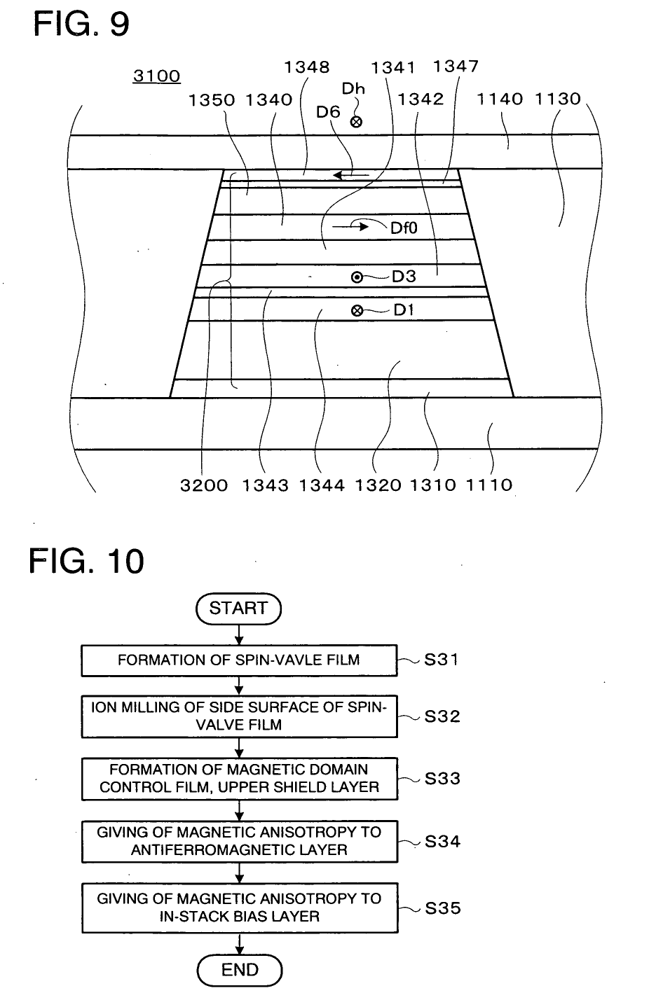

FIG. 9 is a sectional view showing a section of a current-perpendicular-to-plane type magnetoresistive effect element 3100 according to a third embodiment of the present invention.

In the magnetoresistive effect element 3100 according to this embodiment, a spin-valve film 3200 includes a separating layer 1347 and an in-stack bias layer 1348. Namely, the magnetoresistive effect element 3100 includes the separating layer 1347 and the in-stack bias layer 1348 instead of the exchange bias layer 1345 and the upper electrode layer 1346 in the second embodiment.

In this embodiment, the separating layer 1347 and the in-stack bias layer 1348 function as the longitudinal bias mechanism portion which applies the longitudinal bias magnetic field to the magnetization free layer 1340.

The separating layer 1347 is used to prevent element diffusion due to heat used when the magnetic anisotropy is given.

The in-stack bias layer 1348 is made of a magnetized hard magnetic material (as an example of a desirable material, a CoPt alloy or a CoCrPt alloy is cited).

The in-stack bias layer 1348 has a magnetization direction D6, and the direction of the longitudinal bias magnetic field is determined by this magnetization direction D6. In FIG. 9, the magnetization direction D6 is directed to the left of the paper surface. Contrary to this, the magnetization direction D6 may be directed to the left of the paper surface. Magnetostatic couplings M1 and M2 occur between end portions of the in-stack bias layer 1348 and the magnetization free layer 1340, and the initial magnetization direction Df0 of the magnetization free layer 1340 occurs. This initial magnetization direction Df0 is nearly antiparallel to the magnetization direction D6 of the in-stack bias layer 1348.

At this time, the initial magnetization direction Df0 is usually made nearly parallel to the film surface of the magnetoresistive effect film and nearly perpendicular to the magnetization direction of the magnetization fixed layer 1342. Namely, the magnetization direction D6 which produces antiferromagnetic magnetic order in the in-stack bias layer 1348 is usually nearly perpendicular to the magnetization direction D3 of the magnetization fixed layer 1342.

The bias point BP can be adjusted by displacing the angle o formed by the magnetization direction D6 of the in-stack bias layer 1348 (nearly antiparallel to the initial magnetization direction Df0 of the magnetization free layer 1340) and the magnetization direction D3 of the magnetization fixed layer 1342 from the perpendicular angle. Namely, by making the absolute value of the angle θ larger than 10° and smaller than 70° (10°<|θ|<70°), the bias point can be made more than 50%. Incidentally, if the magnetization directions D6 and D3 are parallel, the angle θ=0° holds (θ=180° if they are antiparallel).

This method (the method for adjusting the bias point by the magnetization directions of the in-stack bias layer 1348 and the magnetization fixed layer 1342) correspond to the method (3) out of the methods (1) to (4) described in the first embodiment. In this embodiment, instead of this method, it is also possible to adopt the methods (1), (2), or (4) described in the first embodiment.

### (Fabrication of Magnetoresistive Effect Element 3100)

A method for fabricating the current-perpendicular-to-plane type magnetoresistive effect element 3100 will be described.

FIG. 10 is a flowchart showing an example of a procedure for fabricating the current-perpendicular-to-plane type magnetoresistive effect element 3100.

### (1) Formation of Spin-Valve Film 3200, Etching of Side Surface thereof, Formation of Magnetic Domain Control Film 1120 and Upper Shield Layer 1140 (Steps S31 to S33)

The spin-valve film 3200 is formed on the substrate not shown. Namely, in addition to the deposition of the lower shield layer 1110 to the magnetization free layer 1340 in the first-embodiment, the separating layer 1347 and the in-stack bias layer 1348 are deposited.

In other respects, steps S31 to S33 are not essentially different from steps S11, S13, and S14 in the first embodiment, so that a detailed description is omitted.

### (2) Giving of Exchange Coupling Magnetic Field to Antiferromagnetic Layer 1320 (Step S34)

An exchange coupling magnetic field (magnetic anisotropy) is given to the antiferromagnetic layer 1320. More specifically, the exchange coupling magnetic field can be given by combining the application of a magnetic field and heat treatment. Namely, the first magnetic field H1 is applied in a state where the antiferromagnetic layer 1320 is heat-treated to the first temperature T1 higher than the first blocking temperature, and then the antiferromagnetic layer 1320 is cooled.

### (3) Giving of Exchange Coupling Magnetic Field to In-Stack Bias Layer 1348 (Step S35)

A magnetic anisotropy is given to the in-stack bias layer 1348. Namely, the second magnetic field H2 is applied in a state where the in-stack bias layer 1348 is heat-treated to the second temperature T2 (lower than the first temperature) higher than the second blocking temperature, and then the exchange bias layer 1345 is cooled.

By displacing the direction of the magnetic field H2 to the in-stack bias layer 1345 from the direction perpendicular to the direction of the magnetic field H1 to the antiferromagnetic layer 1320, the bias point can be adjusted. More specifically, the direction of the magnetic field H1 when the antiferromagnetic layer 1320 is heat-treated is made 100° or larger and smaller than 160° with respect to the direction of the magnetic field H2 when the in-stack bias layer 1348 is heat-treated. As a result, the bias point BP can be made more than 50%.

### Modified Example of Third Embodiment

The current-perpendicular-to-plane type magnetoresistive effect element, as a longitudinal bias mechanism, may include both the in-stack bias layer 1348 and the magnetic domain control film 1120.

Also in this case, the bias point BP can be adjusted by displacing the angle of the magnetic moment of the in-stack bias layer 1348.

Incidentally, the current-perpendicular-to-plane type magnetoresistive effect elements according to the above first to third embodiments are all bottom-type magnetoresistive effect elements in which the magnetization fixed layer 1342, the intermediate layer 1341, and the magnetization free layer 1340 are stacked in this order from the bottom. Instead of this, a top-type magnetoresistive effect element in which the magnetization free layer 1340, the intermediate layer 1341, and the magnetization fixed layer 1342 are stacked in this order from the bottom may be used.

### (Magnetic Reproducing Apparatus)

Next, a magnetic reproducing apparatus equipped with the magnetoresistive effect element according to any of the embodiments of the present invention. The magnetoresistive effect element according to any of the embodiments of the present invention, for example, is incorporated in a recording/reproducing integral type magnetic head assembly, and can be mounted in a recording/reproducing apparatus.

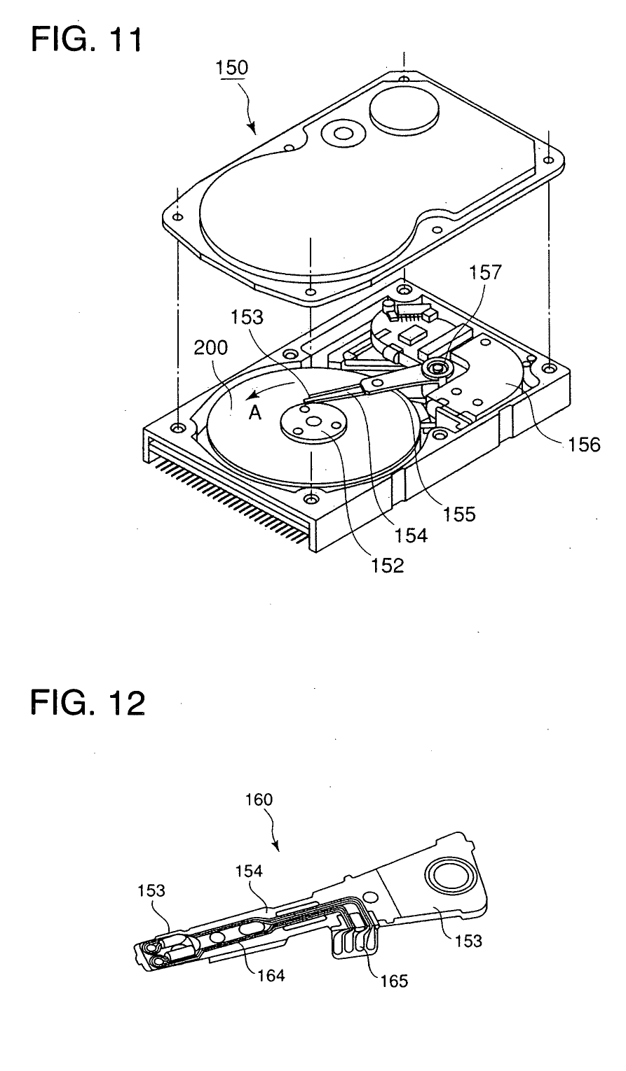

FIG. 11 is a perspective view of a major portion exemplifying a schematic structure of such a magnetic recording/reproducing apparatus. This magnetic recording/reproducing apparatus 150 is an apparatus of a type using a rotary actuator. In this figure, a magnetic recording medium disk 200 is mounted on a spindle 152 and rotated in a direction of arrow A by means of a motor not shown which responds to a control signal from a drive unit control part not shown.

The magnetic recording/reproducing apparatus 150 may include plural magnetic recording medium disks. The magnetic recording medium disk may be either an “in-plane recording system” in which the magnetization direction of recording bits is nearly parallel to a disk surface or a “perpendicular recording system” in which the magnetization direction of recording bits is nearly perpendicular to the disk surface.

A head slider 153 which records/reproduces information stored in the magnetic recording medium disk is attached to a tip of a thin filmy suspension 154. Here, the head slider 153 is equipped with, for example, the magnetoresistive effect element or the magnetic head according to any of the above-described embodiments in the vicinity of its tip.

If the magnetic recording medium disk rotates, an air bearing surface (ABS) of the head slider 153 is held at a predetermined flying height from the surface of the magnetic recording medium disk. Incidentally, the slider may be a so-called “contact traveling type” which is in contact with the magnetic recording medium disk.

The suspension 154 is connected to one end of an actuary arm 155 having a bobbin portion for holding a drive coil not shown and so on. A voice coil motor 156 which is a kind of linear motor is provided at the other end of the actuator arm 155. The voice coil motor 156 is constituted of a drive coil not shown which is wound onto the bobbin portion of the actuator arm 155 and a magnetic circuit including permanent magnets arranged so as to face each other with the coil therebetween and facing yokes.

The actuator arm 155 is held by two ball bearings not shown which are provided above and below a spindle 157, and is freely rotatable and slidable by means of the voice coil motor 156.

FIG. 12 is an enlarged perspective view showing a magnetic head assembly according to an embodiment of the present invention. This figure shows the magnetic head assembly in front of the actuator arm 155, which is viewed from the disk side.

A magnetic head assembly 160 includes the actuator arm 155 having, for example, the bobbin portion for holding the drive coil and so on, and the suspension 154 is connected to one end of the actuator arm 155. The head slider 153 including the magnetoresistive effect element of the present invention such as described above is attached to the tip of the suspension 154.

The suspension 154 has a leadwire 164 for writing and reading signals, and this lead wire 164 is electrically connected to each electrode of the magnetic head incorporated in the head slider 153. In this figure, numeral 165 denotes an electrode pad of the magnetic head assembly 160.

By including the magnetoresistive effect element such as described above, it becomes possible to certainly read information magnetically recorded on the magnetic recording medium disk 200 at a higher recording density than that in the related art.

### EXAMPLE 1

Current-perpendicular-to-plane type magnetoresistive effect elements are fabricated, and the relations between the current induced magnetization switching and the bias point is examined.

Ta [5 nm] is used for the foundation layer 1310, PtMn [15 nm] is used for the antiferromagnetic layer 1320, Co₉₀Fe₁₀ is used for the ferromagnetic layer 1344, Ru [0.85 nm] is used for the magnetic coupling layer 1343, Fe₅₀Co₅₀ is used for the magnetization fixed layer 1342, Cu [5 nm] is used for the intermediate layer 1341, Co₉₀Fe₁₀ [1 nm]/Ni₈₃Fe₁₇ [3.5 nm] is used for the magnetization free layer 1340, and Cu [5 nm] is used for the protective layer 1350.

The longitudinal bias mechanism is the magnetic domain control film 1120 using a CoCrPt alloy. The magnetization direction of the antiferromagnetic layer 1320 is made nearly perpendicular to the magnetization direction of the magnetic domain control film 1120. The thickness of the ferromagnetic layer 1344 and the thickness the magnetization fixed layer 1342 are changed as shown in Table 1. The saturation magnetization of Co₉₀Fe₁₀ used for the ferromagnetic layer 1344 is 1.9 T, and the saturation magnetization of Fe₅₀Co₅₀ used for the magnetization fixed layer 1342 is 2.2 T. Values of magnetic thicknesses Ms1t1 and Ms2t2 calculated using the above values are listed together.

TABLE 1

| | Element | | | | | |
|---|---|---|---|---|---|---|
| | A | B | C | D | E | F |
| | Thickness | Thickness | Thickness | Thickness | Thickness | Thickness |
| Ferromagnetic | 0.5 nm | 1.5 nm | 3.6 nm | 12 nm | 17 nm | 19 nm |
| layer 1344 | 0.95 nmT | 2.9 nmT | 6.8 nmT | 22.8 nmT | 32.3 nmT | 36.1 nmT |
| Ms1t1 | | | | | | |
| Magnetization | 3 nm | 3 nm | 3 nm | 3 nm | 3 nm | 3 nm |
| fixed layer | 6.6 nmT | 6.6 nmT | 6.6 nmT | 6.6 nmT | 6.6 nmT | 6.6 nmT |
| 1342 | | | | | | |
| Ms2t2 | | | | | | |
| Ms1t1/Ms2t2 | 0.14 | 0.43 | 1.03 | 3.45 | 4.89 | 5.47 |

It is defined that the passage of the current from the magnetization free layer 1340 to the magnetization fixed layer 1342 is positive and the passage of the current from the magnetization fixed layer 1342 to the magnetization free layer 1340 is negative. The direction in which the magnetic field is applied antiparallel to the magnetization fixed layer 1342 is defined as the positive direction of the magnetic field.

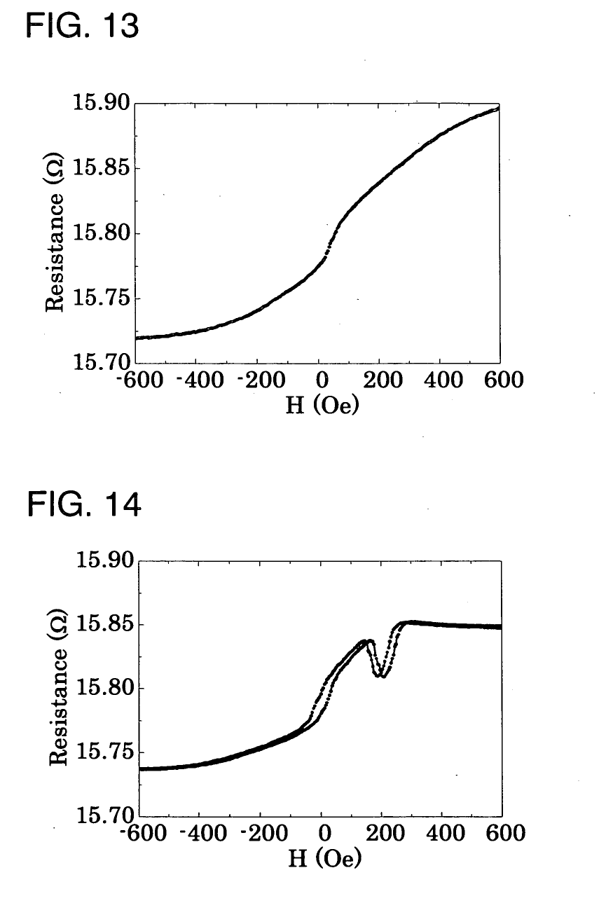

FIG. 13 to FIG. 21 are graphs each showing an R—H curve of the current-perpendicular-to-plane type magnetoresistive effect element.

FIG. 13 shows a case where a current of −1 mA is passed through the element A.

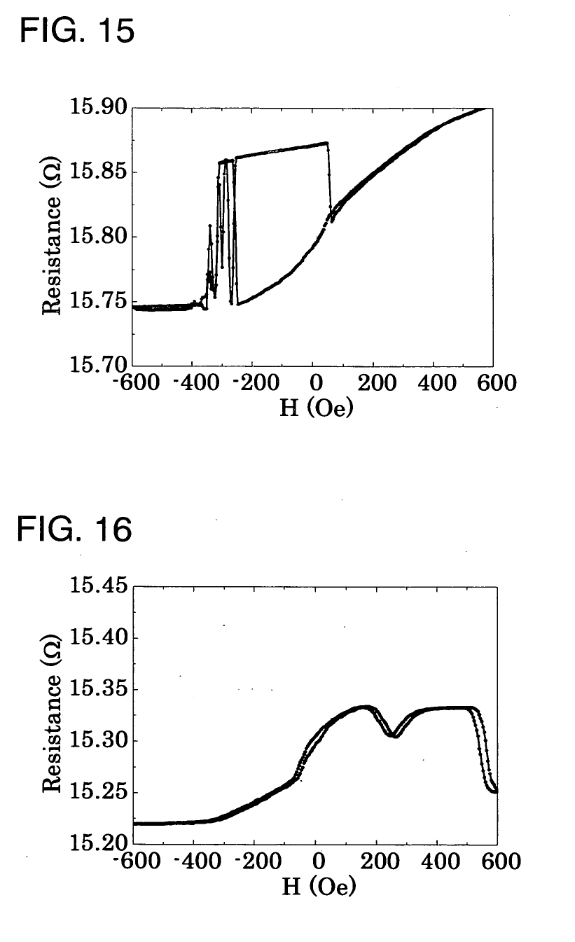

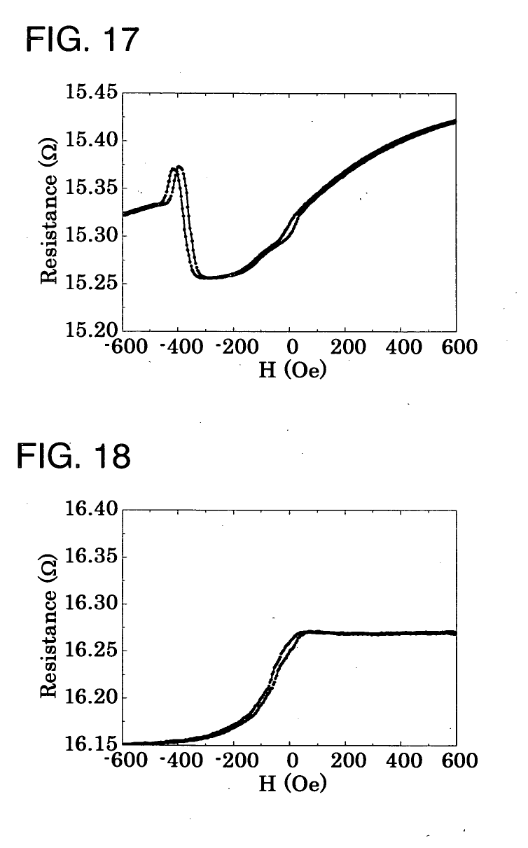

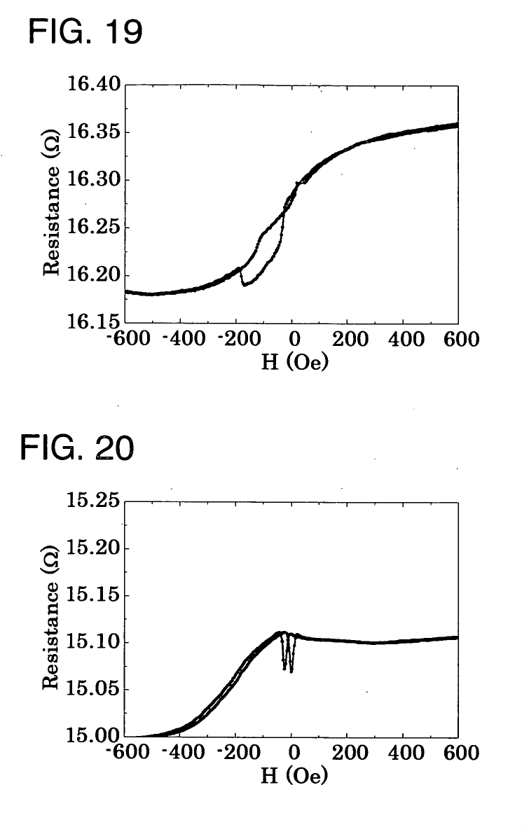

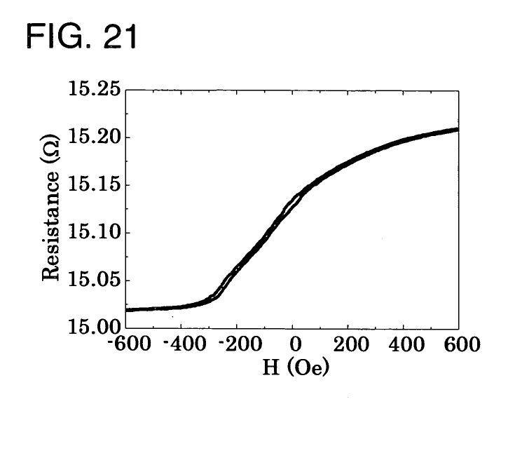

FIG. 14 and FIG. 15 show cases where currents of +2 mA and −2 mA are passed through the element A, respectively. FIG. 16 and FIG. 17 showcases where currents of +2 mA and −2 mA are passed through the element B, respectively. FIG. 18 and FIG. 19 show cases where currents of +2 mA and −2 mA are passed through the element C, respectively. FIG. 20 and FIG. 21 show cases where currents of +2 mA and −2 mA are passed through the element D, respectively.

FIG. 13 shows a good RH curve which does not contain noise due to the current induced magnetization switching. This is because the effect of the current induced magnetization switching is small since the current is as small as −1 mA. As described above, in order to find the bias point, it is desirable to measure the characteristic of the element by such a small current.

Incidentally, in the current value of −1 mA, the sensitivity of the magnetoresistive effect element is low (the amount of change of output voltage accompanying the change of magnetic resistance is small), so that this value is not necessarily a practical value.

Based on FIG. 13, the bias point of the element A is calculated as 30%. Also in the element B to the element F, their bias points are calculated with the current value as −1 mA. As a result, the bias point is 38% in the element B, 50% in the element C, 55% in the element D, 80% in the element E, and 95% in the element F.

In FIG. 14, the resistance reduces great1ywhen the magnetic field H is in the vicinity of 200 [Oe]. In FIG. 15, a large hysteresis is observed when the magnetic field H is in the vicinity of 50 [Oe] to 400 [Oe]. Namely, the element A cannot be said to have a good characteristic as the magnetoresistive effect element. Note that the hysteresis is due to the current induced magnetization switching.

In FIG. 16, the resistance reduces when the magnetic field H is in the vicinity of 250 [Oe] and in a region higher than 500 [Oe]. In FIG. 17, the resistance increases sharply when the magnetic field H is in a region lower than −350 [Oe]. Namely, the element B also cannot be said to have a good characteristic as the magnetoresistive effect element. Note that the hysteresis is due to the current induced magnetization switching.

In FIG. 18, no hysteresis or the like is not observed in the R-H curve, but the resistance change when the magnetic field H changes from −600 [Oe] to +600 [Oe] is 0.12 Ω. This resistance change is smaller compared to a resistance change of 0.18 Ω in the same magnetic field range in FIG. 19. Moreover, the resistance change from the vicinity of 50 [Oe] to the vicinity of 600 [Oe] is extremely small (the sensitivity to a positive magnetic field from the medium is extremely small).

When the current is passed from the magnetization free layer 1340 to the magnetization fixed layer 1342 in the element C as just described, the element C cannot be said to have a good characteristic as the magnetoresistive effect element. Incidentally, a small resistance change in the positive magnetic field in FIG. 18 is also due to the current induced magnetization switching.

In FIG. 19, a hysteresis is observed when the magnetic field H is in the vicinity of 0 [Oe] to −200 [Oe]. However, according to keen examination of this hysteresis by the inventor et al., the hysteresis is observed at a frequency of only two times out of 1000 measurements. Accordingly, by passing the current from the magnetization fixed layer 1342 to the magnetization free layer 1340 in the element C, a high magnetic resistance change can be obtained.

In FIG. 20, a hysteresis is observed when the magnetic field H is in the vicinity of 0 [Oe], and besides the resistance change is 0.11 Ω when the magnetic field H is in a range from −600 [Oe] to +600 [Oe]. This resistance change is smaller compared to a resistance change of 0.19 Ω in the same magnetic field range in FIG. 21. Moreover, the resistance change from the vicinity of 50 [Oe] to the vicinity of 600 [Oe] is extremely small (the sensitivity to a positive magnetic field from the medium is extremely small).

When the current is passed from the magnetization free layer 1340 to the magnetization fixed layer 1342 in the element D as just described, the element D cannot be said to have a good characteristic as the magnetoresistive effect element. Incidentally, little resistance change in the positive magnetic field H in FIG. 20 is also due to the current induced magnetization switching.

In FIG. 21, in either a positive or a negative magnetic field, the resistance increases smoothly and greatly with the increase of the absolute value of the magnetic field. Accordingly, when the current is passed from the magnetization fixed layer 1342 to the magnetization free layer 1340 in the element D, the element D can be said to have a good characteristic as the magnetoresistive effect element.

In the element E, the bias point is 80% and almost the same amount of magnetic resistance change as that of the element D can be obtained. On the other hand, in the element F, the bias point is 95% and the resistance change with respect to the magnetic field in the positive direction is extremely small. Namely, the element F lacks in balance as the magnetoresistive effect element (the magnetic field in the negative direction can be measured, but it is difficult to measure the magnetic field in the positive direction).

As described above, by passing the current from the magnetization fixed layer 1342 to the magnetization free layer 1340 and making the bias point 50% or more, it is possible to avoid noise due to the current induced magnetization switching and thereby obtain a high output. Considering the avoidance of hysteresis and the result of the element F, it turns out that a bias point not less than 55% nor more than 80% is more preferable.

Here, in the elements C and D, the ratios of magnetic thicknesses ((Ms1*t1)/(Ms2*t2)) are 1.03 and 3.45, and the bias points are 50% and 55%, respectively. From this, it is estimated that the bias point becomes substantially more than 50% when the ratio of magnetic thicknesses ((Ms1*t1)/(Ms2*t2)) is approximately 1.2 or more.

### EXAMPLE 2

Elements having the same element structure as in Example 1 in which the thickness of the ferromagnetic layer 1344 is 3.5 nm, the thickness of the magnetization fixed layer 1342 is 3 nm, and a PtMn alloy and an IrMn alloy are used for the antiferromagnetic layer 1320 and among which the angle θ of the direction of the magnetic field when the antiferromagnetic layer 1320 is heat-treated with respect to the magnetization direction D4 of the magnetic domain control film 1120 differs are fabricated.

The same measurements as in Example 1 are performed on the fabricated elements and results thereof are listed in Table 2. The result that the resistance change accompanying the current induced magnetization switching in the positive current occurs is defined as “determination x” and the result that it does not occur is defined as “determination.”.

TABLE 2

| | Antiferromagnetic layer | | Antiferromagnetic layer | |
|---|---|---|---|---|
| Angle | 1320 . . . PtMn | | 1320 . . . IrMn | |
| [°] | Bias point | Determination | Bias point | Determination |
| 110 | 38% | x | 35% | x |
| 100 | 45% | x | 40% | x |
| 90 | 49% | x | 49% | x |
| 80 | 53% | • | 52% | • |
| 70 | 56% | • | 53% | • |
| 60 | 61% | • | 60% | • |
| 50 | 66% | • | 65% | • |
| 40 | 72% | • | 70% | • |
| 30 | 75% | • | 75% | • |
| 20 | 78% | • | 78% | • |
| 10 | 85% | • | 83% | • |

From Table 2, it can be seen that in both the PtMn alloy and the IrMn alloy, the resistance change accompanying the current induced magnetization switching in the positive current does not occur in a range where the angle θ is larger than 10° and 80° or smaller.

However, when the angle θ is 10°, the resistance change with respect to the magnetic field in the positive direction is extremely small (the bias point is 85% in the case of the PtMn alloy, and the bias point is 83% in the case of the IrMn alloy). Namely, the element F lacks in balance as the magnetoresistive effect element (the magnetic field in the negative direction can be measured, but it is difficult to measure the magnetic field in the positive direction). Hence, it is desirable that the angle θ of the magnetic field be in a range larger than 10° and smaller than 90° (more preferably, 80° or smaller).

### EXAMPLE 3

Magnetoresistive effect elements corresponding to the second embodiment of FIG. 7 (elements using the exchange bias layer 1345 as the longitudinal bias mechanism) are fabricated.

The foundation layer 1310, the antiferromagnetic layer 1320, the ferromagnetic layer 1344, the magnetic coupling layer 1343, the magnetization fixed layer 1342, the intermediate layer 1341, the magnetization free layer 1340, and the protective layer have the same structures as those in Example 1, and IrMn is used for the exchange bias layer 1345. The magnetic field when the antiferromagnetic layer 1320 is heat-treated is set to (7500 [Oe]), the heat treatment temperature at this time is set to 290 degrees, and the heat treatment time is set to three hours. The magnetic field when the exchange bias layer 1345 is heat-treated is set to (7500 [Oe]), the heat treatment temperature at this time is set to 270 degrees, and the heat treatment time is set to one hour.

The elements among which the angle θ formed by the direction of the magnetic field H1 when the antiferromagnetic layer 1320 is heat-treated and that of the magnetic field H2 when the exchange bias layer 1345 is heat-treated differs are fabricated.

The same measurements as in Example 1 are performed on the fabricated elements and results thereof are listed in Table 3. The result that the resistance change accompanying the current induced magnetization switching in the positive current occurs is defined as “determination x” and the result that it does not occur is defined as “determination.”.

TABLE 3

| Angle [°] | Bias point | Determination |
|---|---|---|
| 110 | 38% | x |
| 100 | 45% | x |
| 90 | 49% | x |
| 80 | 53% | • |
| 70 | 56% | • |
| 60 | 61% | • |
| 50 | 66% | • |
| 40 | 72% | • |
| 30 | 77% | • |
| 20 | 79% | • |
| 10 | 85% | • |

As shown above, it is known that when the angle is 10° or larger and 90° or smaller, the resistance change accompanying the current induced magnetization switching in the positive current does not occur. Note, however, that when the angle θ is 10°, the bias point is 85%, and the resistance change with respect to the magnetic field in the positive direction is extremely small. Namely, the element lacks in balance as the magnetoresistive effect element (the magnetic field in the negative direction can be measured, but it is difficult to measure the magnetic field in the positive direction).

This shows it is desirable that the angle θ be made larger than 10° and smaller than 90° (more preferably, 80° or smaller).

### Other Embodiments

Embodiments of the present invention are not limited to the above-described embodiments and can be expanded and modified, and the expanded and modified embodiments are also included in the technical scope of the present invention.

What is claimed is:

1. A magnetoresistive effect element, comprising:
a magnetoresistive effect film including a magnetization free layer whose magnetization direction changes according to an external magnetic field, a magnetization fixed layer whose magnetization direction is substantially fixed to one direction, and an intermediate layer placed between the magnetization free layer and the magnetization fixed layer;
a magnetic coupling layer placed on the magnetization fixed layer of the magnetoresistive effect film;
a ferromagnetic layer placed on the magnetic coupling layer;
an antiferromagnetic layer placed on the ferromagnetic layer;
a bias mechanism portion applying a bias magnetic field to the magnetization free layer in a direction nearly parallel to a film surface of the magentoresistive effect film and nearly perpendicular to the magnetization direction of the magnetization fixed layer; and
a pair of electrodes to pass a current in a direction going from the magnetization fixed layer to the magnetization free layer,
wherein a bias point is more than 50%.

2. The element according to claim 1,
wherein the bias point is 55% or more and 80% or less.

3. The element according to claim 1,
wherein a saturation magnetization Ms1 and a thickness t1 of the magnetization fixed layer and a saturation magnetization Ms2 and a thickness t2 of the ferromagnetic layer have the following relation:
1.2≦(Ms1×t1)/(Ms2×t2)<5

4. The element according to claim 1,
wherein an angle of an initial magnetization direction of the magnetization free layer with respect to the magnetization direction of the magnetization fixed layer is 100° or larger and smaller than 160°.

5. The element according to claim 1,
wherein the bias mechanism portion includes a pair of magnetic domain control films placed on side surfaces of the magnetoresistive effect film and contain a hard magnetic material; and
wherein an angle of a magnetization direction of the ferromagnetic layer with respect to a magnetization direction of the magnetic domain control film is larger than 10° and 80° or smaller.

6. A magnetic head, comprising the magnetoresistive effect element according to claim 1.

7. A magnetic reproducing apparatus, comprising the magnetic head according to claim 6 which reproduces information on a magnetic recording medium.

8. A manufacturing method of a magnetoresistive effect element, comprising:
forming a structure comprising: a magnetoresistive effect film including a magnetization free layer whose magnetization direction changes according to an external magnetic field, a magnetization fixed layer whose magnetization direction is substantially fixed to one direction, and an intermediate layer placed between the magnetization free layer and the magnetization fixed layer; a magnetic coupling layer placed on the magnetization fixed layer of the magnetoresistive effect film; a ferromagnetic layer placed on the magnetic coupling layer; an antiferromagnetic layer placed on the ferromagnetic layer; a bias mechanism portion applying to the magnetization free layer a bias magnetic field in a direction nearly parallel to a film surface of the magentoresistive effect film and nearly perpendicular to the magnetization direction of the magnetization fixed layer; and a pair of electrodes to pass a current in a direction going from the magnetization fixed layer to the magnetization free layer; and
giving an initial magnetization direction whose angle with respect to the magnetization direction of the magnetization fixed layer is 100° or larger and smaller than 160° to the magnetization free layer.

9. The method according to claim 8,
wherein the bias mechanism portion includes a pair of magnetic domain control films placed on side surfaces of the magnetoresistive effect film and contain a hard magnetic material; and
wherein the giving the initial magnetization direction to the magnetization free layer comprises giving a magnetization direction whose angle with respect to a magnetization direction of the magnetic domain control film is larger than 10° and 80° or smaller to the ferromagnetic layer.

10. The method according to claim 9,
wherein the giving the magnetization direction to the ferromagnetic layer comprises heat-treating the antiferromagnetic layer while applying a magnetic field in a direction whose angle is larger than 10° and 80° or smaller with respect to the magnetization direction of the magnetic domain control film thereto.

11. The method according to claim 8,
wherein the bias mechanism portion includes an exchange bias layer placed on the magnetization free layer of the magnetoresistive effect film and contains an antiferromagnetic material,
the giving the initial magnetization direction to the magnetization free layer, comprising:
heat-treating the antiferromagnetic layer while applying a magnetic field in a first direction thereto;
heat-treating the exchange bias layer while applying a magnetic field in a second direction thereto; and
an angle of the first direction with respect to the second direction is larger than 10° and 80° or smaller.
